(19) United States
(12) Patent Application Publication
(10) Pub. No.: US 2016/0306050 A1
(43) Pub. Date: Oct. 20, 2016

(54) ELECTRONIC DEVICE, POSITIONING CONTROL METHOD AND STORAGE MEDIUM

(71) Applicant: CASIO COMPUTER CO., LTD., Tokyo (JP)

(72) Inventor: Ryuji SHINGYOJI, Tokyo (JP)

(73) Assignee: CASIO COMPUTER CO., LTD., Tokyo (JP)

(21) Appl. No.: 15/064,483

(22) Filed: Mar. 8, 2016

(30) Foreign Application Priority Data
Apr. 17, 2015 (JP) 2015-084789

(51) Int. Cl. G01S 19/33

(52) U.S. Cl. CPC G01S 19/33

(57) ABSTRACT

An electronic device includes a first positioning-information acquiring module, a second positioning-information acquiring module, and a switching control unit. The first positioning-information acquiring module acquires positioning information based on a first positioning system which is GPS. The second positioning-information acquiring module acquires positioning information based on a second positioning system which is GLONASS. The switching control unit determines the reception state of at least one of positioning information based on the first positioning system and positioning information based on the second positioning system. Based on this determination result, the switching control unit sets any one of positioning based on any one of the first positioning system and the second positioning system and positioning based on both of the first positioning system and the second positioning system.

### CROSS-REFERENCE TO RELATED APPLICATIONS

This application is based upon and claims the benefit of priority from the prior Japanese Patent Application No. 2015-084789, filed Apr. 17 2015, and the entire contents of which are incorporated herein by reference.

### BACKGROUND OF THE INVENTION

1. Field of the Invention

The present invention relates to an electronic device, a positioning control method and a storage medium.

2. Description of Related Art

In the related art, positioning systems using satellites, such as the Global Positioning System (GPS), are used.

Also, in recent years, positioning systems other than GPS have been put to practical use, and positioning systems using artificial satellites, such as Russian Global Navigation Satellite System (GLONASS), are usable.

GLONASS and GPS are the same as each other in that they are positioning systems using satellites, but are different from each other in that GPS uses a code division multiple access (CDMA) system in which electric waves to be transmitted to all satellites have the same frequency; whereas GLONASS uses a frequency division multiple access (FDMA) system in which electric waves to be transmitted to satellites have different frequencies, respectively.

If these positioning systems are used, the number of satellites usable for positioning increases, for example, to about the total of approximately 56 satellites of about 32 satellites of GPS and about 24 satellites of GLONASS. As a result, even in a situation where the GPS satellites are not sufficient for positioning, like in a region of buildings or a mountainous region, if GLONASS is used together, positioning can be more accurately performed.

However, since two positioning systems are used together, power consumption increases, and thus there is a possibility that the drive times of batteries will shorten.

In contrast, a technology disclosed in JP-A-2011-185603 uses predefined map information to determine whether to use only GPS or to use GPS and GLONASS together, thereby reducing power consumption.

However, in the technology disclosed in JP-A-2011-185603, in order to use predefined map information, it is required to generate map information reflecting local environment, and update the map information according to variations in the local environment, and memory capacity for storing the map information is also required.

### SUMMARY OF THE INVENTION

The present invention was made in view of the above described circumstances, and an object of the present invention is to improve positioning performance while suppressing an increase in power consumption.

In order to achieve the object, an electronic device of an aspect of the present invention includes a first positioning-information acquiring module, a second positioning-information acquiring module and a processing unit. The first positioning-information acquiring module acquires positioning information based on a first positioning system using signals which are received from first satellites. The second positioning-information acquiring module acquires positioning information based on a second positioning system using signals which are received from second satellites. The second satellites are different type from the first satellites. The processing unit performs a reception state determining process and a positioning system setting process. The reception state determining process determines at least one of a reception state of signals from the first satellites and a reception state of signals from the second satellites. The positioning system setting process sets a positioning system based on at least one of the first positioning system and the second positioning system based on a determination result of the reception state determining process.

### BRIEF DESCRIPTION OF THE DRAWING

FIG. 1A is a view illustrating the external appearance of an information processing device as an embodiment of an electronic device of the present invention, and FIG. 1B is a block diagram illustrating the hardware configuration of the information processing device.

FIG. 2 is a functional block diagram illustrating functional components for performing a positioning control process, as some of the functional components of the information processing device of FIGS. 1A and 1B.

FIG. 3 is a flow chart for explaining the flow of a positioning control process which is performed by the information processing device shown in FIGS. 1A and 1B and having the functional components of FIG. 2.

FIG. 4 is a flow chart for explaining the flow of a positioning control process which is performed by an information processing device according to a second embodiment.

FIG. 5 is a flow chart for explaining the flow of a positioning control process which is performed by an information processing device according to a third embodiment.

### DETAILED DESCRIPTION OF THE PREPARED EMBODIMENT

Hereinafter, embodiments of the present invention will be described with reference to the accompanying drawings.

[Hardware Configuration]

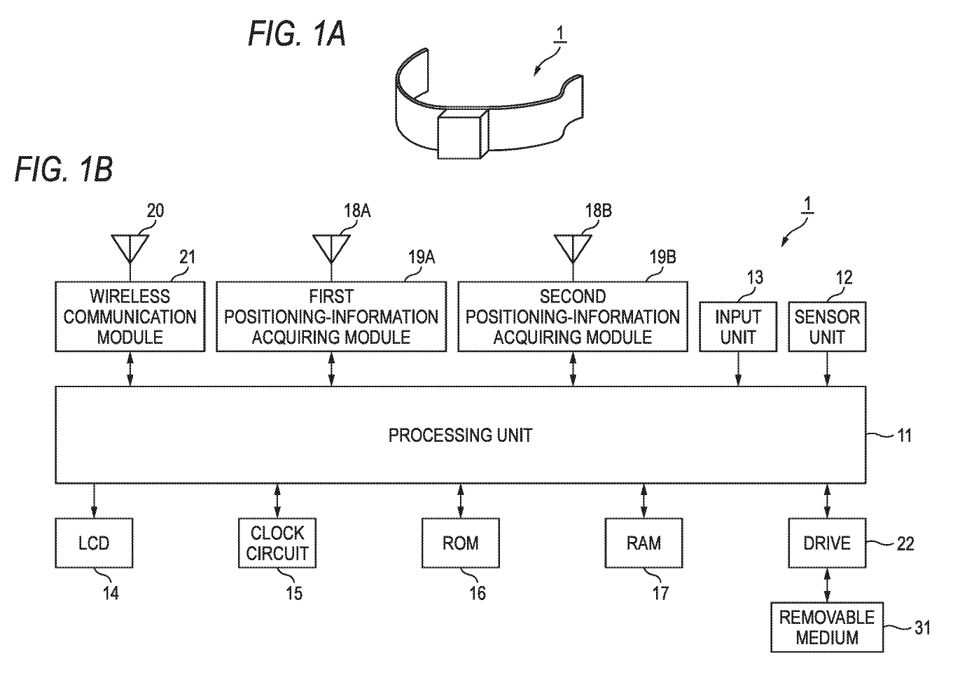

FIG. 1A is a view illustrating the external appearance of an information processing device 1 as an embodiment of an electronic device of the present invention, and FIG. 1B is a block diagram illustrating the hardware configuration of the information processing device.

The information processing device 1 is a terminal device which can be worn around a user's arm or the like, and has a function of performing positioning using signals which are received from different satellites. In the present embodiment, the information processing device 1 has a positioning function based on GPS and a positioning function based on GLONASS. Also, according to reception environment, the information processing device 1 uses at least one of GPS and GLONASS to perform positioning. This information processing device 1 enables a user to acquire a more accurate current location by lower-power-consumption control.

As shown in FIG. 1B, the information processing device 1 includes a processing unit 11, a sensor unit 12, an input unit 13, a liquid crystal display (LCD) 14, a clock circuit 15, a read only memory (ROM) 16, a random access memory (RAM) 17, a GPS (Global Positioning System) antenna 18A which serves as a first antenna, a GLONASS antenna 18B which serves as a second antenna, a first positioning-information acquiring module 19A, a second positioning-information acquiring module 19B, a wireless communication antenna 20, a wireless communication module 21, and a drive 22.

The processing unit 11 is configured by an arithmetic processing unit such as a central processing unit (CPU), and controls the operations of the whole of the information processing device 1. For example, the control unit 11 performs a variety of processing according to a program recorded in the ROM 16, such as a program for a positioning control process (to be described below).

The sensor unit 12 includes various sensors such as a 3-axis gyroscope, a geomagnetic sensor, a gyro sensor, a pressure sensor, or a temperature sensor.

The input unit 13 is configured by various buttons, electrostatic capacity type or resistive film type location input sensors which are formed on the display area of the LCD 14, and the like, and inputs a variety of information according to user's instruction operations.

The LCD 14 outputs images according to instructions of the processing unit 11. For example, the LCD 14 displays various images and interface screens. In the present embodiment, the location input sensors of the input unit 13 are disposed on the LCD 14, whereby a touch panel is configured.

The clock circuit 15 generates a time signal from a signal which is generated by a system clock or an oscillator, and outputs a current time.

The ROM 16 is configured by, for example, serial flash memories, and stores information such as a control program executable by the processing unit 11.

The RAM 17 provides a work area when the processing unit 11 performs a variety of processing.

The GPS antenna 18A converts signals which are transmitted from satellites in GPS (which are first satellites), into electric signals, and outputs the converted electric signals (hereinafter, referred to as “GPS signals”) to the first positioning-information acquiring module 19A.

The GLONASS antenna 18B converts signals which are transmitted from satellites in GLONASS (which are second satellites), into electric signals, and outputs the converted electric signals (hereinafter, referred to as “GLONASS signals”) to the second positioning-information acquiring module 19B.

The first positioning-information acquiring module 19A retrieves the location (latitude, longitude, and altitude) of the information processing device 1, and the current time which is indicated by GPS, based on GPS signals input from the GPS antenna 18A. Also, the first positioning-information acquiring module 19A outputs information representing the retrieved location and the retrieved time and information on GPS (hereinafter, referred to as “GPS information”) to the processing unit 11.

The second positioning-information acquiring module 19B retrieves the location (latitude, longitude, and altitude) of the information processing device 1 and the current time which is indicated by GLONASS, based on GLONASS signals input from the GLONASS antenna 18B. Also, the second positioning-information acquiring module 19B outputs information representing the retrieved location and the retrieved time and information on GLONASS (hereinafter, referred to as “GLONASS information”) to the processing unit 11.

The wireless communication antenna 20 is an antenna capable of receiving electric waves of frequencies corresponding to wireless communication which can be used by the wireless communication module 21, and is configured by, for example, a loop antenna or a rod antenna. The wireless communication antenna 20 transmits electric signals for wireless communication input from the wireless communication module 21, as electromagnetic waves, and converts received electromagnetic waves into electric signals, and outputs the electric signals to the wireless communication module 21.

The wireless communication module 21 transmits signals to other devices through the wireless communication antenna 20, in response to instructions of the processing unit 11. Also, the wireless communication module 21 receives signals transmitted from other devices, and outputs information representing the received signals to the processing unit 11.

In the drive 22, a removable medium 31 which is composed of a magnetic disk, an optical disk, a magneto-optical disk, or a semiconductor memory (such as a flash memory) can be appropriately installed. The removable medium 31 can store a variety of information such as image information.

[Functional Configuration]

Now, the functional configuration of the information processing device 1 will be described.

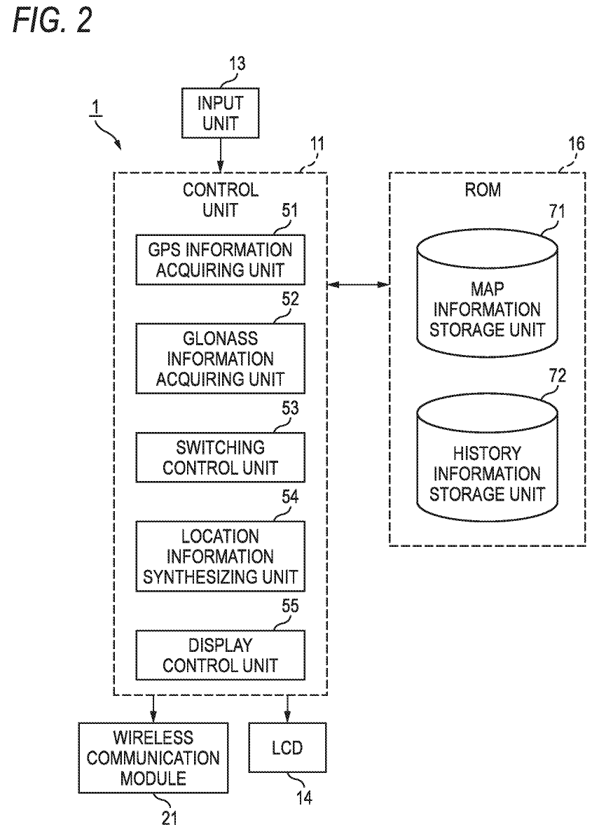

FIG. 2 is a functional block diagram illustrating functional components for performing a positioning control process as some of the functional components of the information processing device 1 of FIGS. 1A and 1B.

A positioning control process means a series of processes for acquiring a current location by performing positioning based on at least one of the first positioning-information acquiring module 19A and the second positioning-information acquiring module 19B.

In a case where a positioning control process is performed, as shown in FIG. 2, in the processing unit 11, a GPS information acquiring unit 51, a GLONASS information acquiring unit 52, a switching control unit 53, a location information synthesizing unit 54, and a display control unit 55 function. Also, in the ROM 16, a map information storage unit 71 and a history information storage unit 72 are formed.

The map information storage unit 71 stores map information for displaying the current location of the information processing device 1 thereon.

The history information storage unit 72 sequentially stores the history of current location acquired by the positioning control process.

The GPS information acquiring unit 51 acquires GPS information (signals) on GPS from the first positioning-information acquiring module 19A. In the present embodiment, the GPS information acquiring unit 51 acquires location information and time information which can be acquired from GPS signals, the number of reception satellites of the GPS satellites, and the levels of reception signals from the individual GPS satellites, as GPS information. The GPS information acquiring unit 51 sequentially stores the acquired GPS information in the history information storage unit 72.

The GLONASS information acquiring unit 52 acquires GLONASS information (signals) on GLONASS from the second positioning-information acquiring module 19B. In the present embodiment, the GLONASS information acquiring unit 52 acquires location information and time information which can be acquired from GLONASS signals, as GLONASS information. Also, similarly to the GPS information acquiring unit 51, the GLONASS information acquiring unit 52 may acquire the number of reception satellites of the GLONASS satellites and the levels of reception signals from the individual GLONASS satellites, in addition to location information and time information which are acquired from GLONASS signals. The GLONASS information acquiring unit 52 sequentially stores the acquired GLONASS information in the history information storage unit 72.

The switching control unit 53 determines GPS signal reception environment based on GPS information which is acquired by the GPS information acquiring unit 51, and performs switching between positioning base on only the first positioning-information acquiring module 19A and positioning base on both of the first positioning-information acquiring module 19A and the second positioning-information acquiring module 19B.

Specifically, the switching control unit 53 determines whether a state where the number of reception satellites of the GPS satellites which is shown in the GPS information is 8 or more, and the C/N (Carrier to Noise ratio) average of the levels of reception signals from the individual GPS satellites is 30 [dB] or more has continued for a predetermined period (such as 5 seconds or more) (hereinafter, this condition will be referred to as the “satisfactory-reception-environment condition”). In a case where the satisfactory-reception-environment condition is satisfied, the switching control unit 53 determines that the GPS signal reception environment is satisfactory, and performs positioning base on only the first positioning-information acquiring module 19A. In this case, the switching control unit 53 outputs an operation stop signal to the second positioning-information acquiring module 19B, thereby preventing the second positioning-information acquiring module 19B from consuming electric power. Meanwhile, in a case of determining that the GPS signal reception environment is not satisfactory, the switching control unit 53 performs positioning base on both of the first positioning-information acquiring module 19A and the second positioning-information acquiring module 19B.

In a case where positioning base on both of the first positioning-information acquiring module 19A and the second positioning-information acquiring module 19B is performed, the location information synthesizing unit 54 performs conversion between a location coordinate system based on GPS and a location coordinate system based on GLONASS, thereby synthesizing the positioning results of GPS and GLONASS, thereby calculating the current location. Therefore, it is possible to acquire a more accurate current location based on not only the number of reception satellites of GPS but also the number of reception satellites of GLONASS. Also, the current location calculated by the location information synthesizing unit 54 is sequentially stored in the history information storage unit 72.

Based on the location information acquired by the GPS information acquiring unit 51 or the location information calculated by the location information synthesizing unit 54, the display control unit 55 displays the current location on the map information stored in the map information storage unit 71. In the present embodiment, the display control unit 55 transmits the map information having the current location superimposed thereon, to another device such as a smart phone or a list terminal, through the wireless communication module 21, thereby performing current location display. However, the display control unit 55 may display the current location on the LCD 14.

[Operations]

Now, the operations of the information processing device 1 will be described.

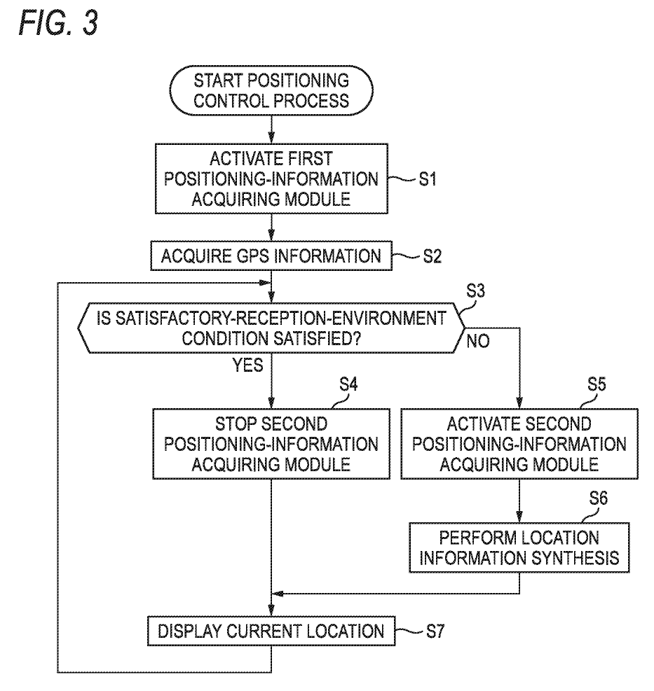

FIG. 3 is a flow chart for explaining the flow of a positioning control process which is performed by the information processing device 1 shown in FIGS. 1A and 1B and having the functional configuration of FIG. 2.

If an operation for activating the positioning control process is performed on the input unit 13 by a user, the positioning control process is started.

In STEP 51, the switching control unit 53 activates the first positioning-information acquiring module 19A.

In STEP S2, the switching control unit 53 acquires GPS information from the GPS information acquiring unit 51. Specifically, the switching control unit 53 acquires the number of reception satellites of GPS satellites and the levels of reception signals from the individual GPS satellites, from the GPS information.

In STEP S3, the switching control unit 53 determines whether the satisfactory-reception-environment condition is satisfied. Specifically, the switching control unit 53 determines whether a state where the number of reception satellites of the GPS satellites which is shown in the GPS information is 8 or more and the C/N average of the levels of reception signals from the individual GPS satellites is 30 [dB] or more has continued for the predetermined period (for example, 5 seconds or more).

In a case where the satisfactory-reception-environment condition is satisfied, the determination result of STEP S3 becomes “YES”, and the process proceeds to STEP S4.

Meanwhile, in a case where the satisfactory-reception-environment condition is not satisfied, the determination result of STEP S3 becomes “NO”, and the process proceeds to STEP S5.

In STEP S4, the switching control unit 53 stops the operation of the second positioning-information acquiring module 19B. Also, as a mode in which the operation of the second positioning-information acquiring module 19B is stopped, it is possible to set various modes for making power consumption less than that during normal operation, such as modes in which electric power for the second positioning-information acquiring module 19B is cut off, or the second positioning-information acquiring module 19B is switched to a sleep state, or the second positioning-information acquiring module 19B is intermittently activated.

In STEP S5, the switching control unit 53 activates the second positioning-information acquiring module 19B. Specifically, the switching control unit 53 performs control such that the second positioning-information acquiring module 19B normally operates.

In STEP S6, the location information synthesizing unit 54 synthesizes the location information acquired by the GPS information acquiring unit 51 and the location information acquired by the GLONASS information acquiring unit 52, thereby calculating the current location.

After STEP S4 or STEP S6, the process proceeds to STEP S7.

In STEP S7, the display control unit 55 displays the current location on the map information stored in the map information storage unit 71. Specifically, in a case where the satisfactory-reception-environment condition is satisfied, whereby positioning is performed by only the first positioning-information acquiring module 19A, the display control unit 55 displays the current location on the map information, based on the location information acquired by the GPS information acquiring unit 51. Meanwhile, in a case where the satisfactory-reception-environment condition is not satisfied, whereby positioning is performed by both of the first positioning-information acquiring module 19A and the second positioning-information acquiring module 19B, the display control unit 55 displays the current location calculated by the location information synthesizing unit 54, on the map information.

After STEP S7, the process proceeds to STEP S3.

Also, in a case where an operation for stopping the positioning control process is performed on the input unit 13 by the user, the positioning control process finishes.

According to this process, in the information processing device 1, in a case where the GPS signal reception environment satisfies the satisfactory-reception-environment condition, positioning is performed by only GPS; whereas in a case where the GPS signal reception environment does not satisfy the satisfactory-reception-environment condition, positioning is performed by both of GPS and GLONASS.

Therefore, in an electronic device having a positioning function based on GPS and a positioning function based on GLONASS, it is possible to acquire a more accurate current location by lower-power-consumption control.

Therefore, according to the information processing device 1, it is possible to improve positioning performance while suppressing an increase in power consumption.

### Second Embodiment

Now, a second embodiment of the present invention will be described.

An information processing device 1 according to the present embodiment additionally acquires information on a reception mode (a 2D mode or a 3D Fix mode) in positioning of GPS, the number of satellites used in positioning of GPS (the number of satellites used in positioning), satellite arrangement, and location errors, in addition to the information in the case of the first embodiment, as GPS information. Subsequently, the information processing device 1 according to the present embodiment re-determines the GPS signal reception environment based on the additionally acquired GPS information, in addition to the satisfactory-reception-environment condition of the first embodiment. According to this determination result, the information processing device 1 according to the present embodiment performs switching between positioning based on only the first positioning-information acquiring module 19A and positioning based on both of the first positioning-information acquiring module 19A and the second positioning-information acquiring module 19B, thereby improving the accuracy of positioning.

Hereinafter, the present embodiment will be described with a focus on differences from the information processing device 1 of the first embodiment.

The hardware configuration of the information processing device 1 of the present embodiment is identical to the case of the first embodiment shown in FIG. 1B.

Also, the information processing device 1 of the present embodiment is different from the functional configuration of the first embodiment shown in FIG. 2 in the configurations of the GPS information acquiring unit 51 and the switching control unit 53.

In the present embodiment, the GPS information acquiring unit 51 acquires GPS information on GPS from the first positioning-information acquiring module 19A. In the present embodiment, the GPS information acquiring unit 51 acquires location information and time information which can be acquired from GPS signals, and information on the number of reception satellites of the GPS satellites, the levels of reception signals from the individual GPS satellites, the reception mode (the 2D mode or the 3D Fix mode) in positioning of GPS, the number of satellites used in positioning of GPS, satellite arrangement, and location errors, as GPS information. The GPS information acquiring unit 51 sequentially stores the acquired GPS information in the history information storage unit 72.

The switching control unit 53 determines GPS signal reception environment based on the GPS information which is acquired by the GPS information acquiring unit 51, and performs switching between positioning based on only the first positioning-information acquiring module 19A and positioning based on both of the first positioning-information acquiring module 19A and the second positioning-information acquiring module 19B.

Specifically, the switching control unit 53 determines whether the satisfactory-reception-environment condition is satisfied in GPS. In a case where the satisfactory-reception-environment condition is satisfied, the switching control unit 53 determines that the GPS signal reception environment is satisfactory, and performs positioning based on only the first positioning-information acquiring module 19A. In this case, the switching control unit 53 outputs an operation stop signal to the second positioning-information acquiring module 19B, thereby preventing the second positioning-information acquiring module 19B from consuming electric power. Meanwhile, in a case of determining that the GPS signal reception environment is not satisfactory, the switching control unit 53 performs positioning based on both of the first positioning-information acquiring module 19A and the second positioning-information acquiring module 19B.

Also, after performing switching between positioning based on only the first positioning-information acquiring module 19A and positioning based on both of the first positioning-information acquiring module 19A and the second positioning-information acquiring module 19B, the switching control unit 53 acquires the information on the reception mode (the 2D mode or the 3D Fix mode) in positioning of GPS, the number of satellites used in positioning of GPS, satellite arrangement, and location errors (hereinafter, referred to as “additional GPS information”). Subsequently, the switching control unit 53 re-determines the GPS signal reception environment based on the additional GPS information. According to this determination result, the switching control unit performs switching between positioning based on only the first positioning-information acquiring module 19A and positioning based on both of the first positioning-information acquiring module 19A and the second positioning-information acquiring module 19B.

Specifically, the switching control unit 53 determines whether the satisfactory-reception-environment condition is satisfied in GPS, and whether an additional satisfactory-reception-environment condition is satisfied in GPS. In the present embodiment, the switching control unit 53 sets, as the additional satisfactory-reception-environment condition, a condition that a state where the reception mode which is shown by the additional GPS information is the 3D Fix mode, and the number of satellites used in positioning is larger than 6, and satellite arrangement is appropriate (for example, DOP (Dilution Of Precision)<3), and location error information is not inappropriate (for example, GST (GNSS pseudorange error STatistics)<5) should continue for the predetermined period (for example, 5 seconds or more). In a case where both of the satisfactory-reception-environment condition and the additional satisfactory-reception-environment condition are satisfied, the switching control unit 53 determines that the GPS signal reception environment is better, and performs positioning based on only the first positioning-information acquiring module 19A. Meanwhile, in a case of determining that the GPS signal reception environment is not better, the switching control unit 53 performs positioning based on both of the first positioning-information acquiring module 19A and the second positioning-information acquiring module 19B.

[Operations]

Now, the operations of the information processing device 1 will be described.

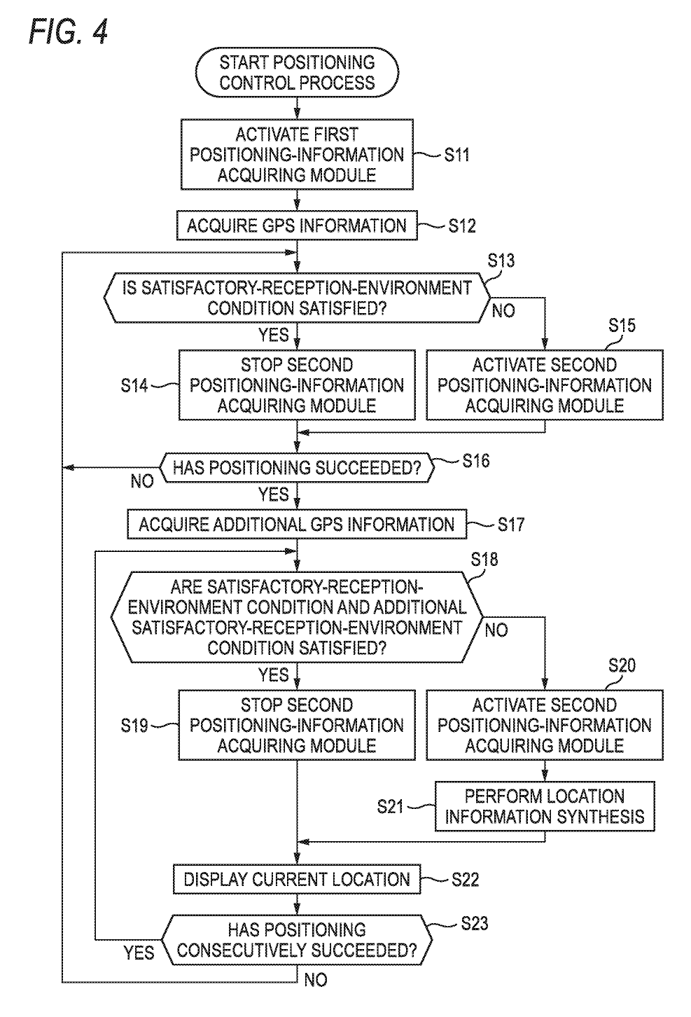

FIG. 4 is a flow chart for explaining the flow of a positioning control process which is performed by the information processing device 1 according to the second embodiment.

If an operation for activating the positioning control process is performed on the input unit 13 by a user, the positioning control process is started.

In FIG. 4, the process from STEP S11 to STEP S15 is identical to the process from STEP 51 to STEP S5 shown in FIG. 3.

In STEP S16, the switching control unit 53 determines whether positioning based on only GPS or positioning based on both of GPS and GLONASS has succeeded. For example, the switching control unit 53 can determine whether positioning has succeeded, based on whether the reception mode is the 2D mode or the 3D Fix mode.

In a case where positioning based on only GPS or positioning based on both of GPS and GLONASS has succeeded, the determination result of STEP S16 becomes “YES”, and the process proceeds to STEP S17.

Meanwhile, in a case where positioning based on only GPS or positioning based on both of GPS and GLONASS has not succeeded, the determination result of STEP S16 becomes “NO”, and the process proceeds to STEP S13.

In STEP S17, the switching control unit 53 acquires the additional GPS information from the GPS information acquiring unit 51.

In STEP S18, the switching control unit 53 determines whether the satisfactory-reception-environment condition and the additional satisfactory-reception-environment condition are satisfied. Specifically, the switching control unit 53 determines whether a state where the number of reception satellites of the GPS satellites which is shown by the GPS information is 8 or more and the C/N average of the levels of reception signals from the individual GPS satellites is 30 [dB] or more has continued for the predetermined period (for example, 5 seconds or more), as the satisfactory-reception-environment condition. Also, the switching control unit 53 determines whether a state where the reception mode which is shown by the additional GPS information is the 3D Fix mode, and the number of satellites used in positioning is larger than 6, and satellite arrangement is appropriate (for example, DOP<3), and location error information is not inappropriate (for example, GST<5) has continued for the predetermined period (for example, 5 seconds or more), as the additional satisfactory-reception-environment condition.

In a case where the satisfactory-reception-environment condition and the additional satisfactory-reception-environment condition are satisfied, the determination result of STEP S18 becomes “YES”, and the process proceeds to STEP S19.

Meanwhile, in a case where the satisfactory-reception-environment condition and the additional satisfactory-reception-environment condition are not satisfied, the process proceeds to STEP S20.

In STEP S19, the switching control unit 53 stops the operation of the second positioning-information acquiring module 19B. Also, as a mode in which the operation of the second positioning-information acquiring module 19B is stopped, it is possible to set various modes for making power consumption less than that during normal operation, such as modes in which electric power for the second positioning-information acquiring module 19B is cut off, or the second positioning-information acquiring module 19B is switched to a sleep state, or the second positioning-information acquiring module 19B is intermittently activated.

In STEP S20, the switching control unit 53 activates the second positioning-information acquiring module 19B. Specifically, the switching control unit 53 performs control such that the second positioning-information acquiring module 19B normally operates.

In STEP S21, the location information synthesizing unit 54 synthesizes the location information acquired by the GPS information acquiring unit 51 and the location information acquired by the GLONASS information acquiring unit 52, thereby calculating the current location.

After STEP S19 or STEP S21, the process proceeds to STEP S22.

In STEP S22, the display control unit 55 displays the current location on the map information stored in the map information storage unit 71. Specifically, in a case where the satisfactory-reception-environment condition and the additional satisfactory-reception-environment condition are satisfied, whereby positioning based on only the first positioning-information acquiring module 19A is performed, the display control unit 55 displays the current location on the map information, based on the location information acquired by the GPS information acquiring unit 51. Meanwhile, in a case where the satisfactory-reception-environment condition and the additional satisfactory-reception-environment condition are not satisfied, whereby positioning based on both of the first positioning-information acquiring module 19A and the second positioning-information acquiring module 19B is performed, the display control unit 55 displays the current location calculated by the location information synthesizing unit 54, on the map information.

In STEP S23, the switching control unit 53 determines whether positioning based on only GPS or positioning based on both of GPS and GLONASS has consecutively succeeded. For example, the switching control unit 53 can determine whether positioning has consecutively succeeded, based on whether the reception mode is the 2D mode or the 3D Fix mode.

In a case where positioning based on only GPS or positioning based on both of GPS and GLONASS has consecutively succeeded, the determination result of STEP S23 becomes “YES”, and the process proceeds to STEP S18.

Meanwhile, in a case where positioning based on only GPS or positioning based on both of GPS and GLONASS has not consecutively succeeded, the determination result of STEP S23 becomes “NO”, and the process proceeds to STEP S13.

Also, in a case where an operation for stopping the positioning control process is performed on the input unit 13 by the user, the positioning control process finishes.

According to this process, in the information processing device 1, in a case where the GPS signal reception environment satisfies the satisfactory-reception-environment condition, positioning based on only GPS is performed; whereas in a case where the GPS signal reception environment does not satisfy the satisfactory-reception-environment condition, positioning based on both of GPS and GLONASS is performed.

Further, after positioning succeeds, if the GPS signal reception environment satisfies both of the satisfactory-reception-environment condition and the additional satisfactory-reception-environment condition, positioning based on only GPS is performed; whereas in a case where the GPS signal reception environment does not satisfy both of the satisfactory-reception-environment condition and the additional satisfactory-reception-environment condition, positioning based on both of GPS and GLONASS is performed.

Therefore, in an electronic device having a positioning function based on GPS and a positioning function based on GLONASS, it is possible to determine a positioning system whose reception environment is better and acquire a more accurate current location by lower-power-consumption control.

Therefore, according to the information processing device 1, it is possible to improve positioning performance while suppressing an increase in power consumption.

### Third Embodiment

Now, a third embodiment of the present invention will be described.

In the first embodiment and the second embodiment, in a case where the GPS signal reception environment is satisfactory, the information processing device 1 performs positioning based on only GPS; whereas in a case where the GPS signal reception environment is not satisfactory, the information processing device performs positioning based on both of GPS and GLONASS. In contrast, an information processing device 1 of the present embodiment performs positioning based on only GLONASS in a case where GLONASS signal reception environment is better than GPS signal reception environment.

Hereinafter, the present embodiment will be described with a focus on differences from the information processing devices 1 of the first embodiment and the second embodiment.

The hardware configuration of the information processing device 1 of the present embodiment is identical to the case of the first embodiment shown in FIG. 1B.

Also, the information processing device 1 of the present embodiment is different from the functional configuration of the first embodiment shown in FIG. 2 in the configurations of the GLONASS information acquiring unit 52 and the switching control unit 53. Also, the functional configuration of the GPS information acquiring unit 51 of the present embodiment is identical to that of the GPS information acquiring unit 51 of the second embodiment.

In the present embodiment, the GLONASS information acquiring unit 52 acquires GLONASS information on GLONASS from the second positioning-information acquiring module 19B. In the present embodiment, the GLONASS information acquiring unit 52 acquires location information and time information which can be acquired from GLONASS signals, and information on the number of reception satellites of the GLONASS satellites, the levels of reception signals from the individual GLONASS satellites, the reception mode (the 2D mode or the 3D Fix mode) in positioning of GLONASS, the number of satellites used in positioning of GLONASS, satellite arrangement, and location errors, as GLONASS information. The GLONASS information acquiring unit 52 sequentially stores the acquired GLONASS information in the history information storage unit 72.

Based on the GPS information acquired by the GPS information acquiring unit 51 and the GLONASS information acquired by the GLONASS information acquiring unit 52, the switching control unit 53 determines the GPS signal reception environment and the GLONASS signal reception environment, and performs switching to any one of positioning based on only the first positioning-information acquiring module 19A, positioning based on only the second positioning-information acquiring module 19B, and positioning based on both of the first positioning-information acquiring module 19A and the second positioning-information acquiring module 19B.

Specifically, the switching control unit 53 determines whether the satisfactory-reception-environment condition is satisfied in GPS and GLONASS. In a case where the satisfactory-reception-environment condition is satisfied in any one of GPS and GLONASS, the switching control unit 53 determines that the reception environment of the first positioning-information acquiring module 19A or the second positioning-information acquiring module 19B corresponding to GPS or GLONASS satisfying the satisfactory-reception-environment condition is satisfactory, and performs positioning based on only the corresponding module. In this case, the switching control unit 53 outputs an operation stop signal to the module corresponding to GPS or GLONASS which does not satisfy the satisfactory-reception-environment condition, thereby preventing the corresponding module from consuming electric power. Meanwhile, in a case where the satisfactory-reception-environment condition is not satisfied in both of GPS and GLONASS, the switching control unit 53 performs positioning based on both of the first positioning-information acquiring module 19A and the second positioning-information acquiring module 19B. Also, in a case where the satisfactory-reception-environment condition is satisfied in both of GPS and GLONASS, the switching control unit 53 can perform positioning based on a lower-power-consumption module selected from the first positioning-information acquiring module 19A and the second positioning-information acquiring module 19B, or can compare the GPS information and the GLONASS information, and perform positioning based on a module whose reception environment is better.

Also, after performing switching to any one of positioning based on only the first positioning-information acquiring module 19A or only the second positioning-information acquiring module 19B and positioning based on both of the first positioning-information acquiring module 19A and the second positioning-information acquiring module 19B, the switching control unit 53 acquires the additional GPS information, and the information on the reception mode (the 2D mode or the 3D Fix mode) in positioning in GLONASS, the number of satellites used in positioning of GLONASS, satellite arrangement, and location errors (hereinafter, referred to as “additional GLONASS information”). Subsequently, the switching control unit 53 re-determines the GPS signal reception environment or the GLONASS signal reception environment based on the additional GPS information and the additional GLONASS information. According to this determination result, the switching control unit performs switching to any one of positioning based on only the first positioning-information acquiring module 19A, positioning based on only the second positioning-information acquiring module 19B, and positioning based on both of the first positioning-information acquiring module 19A and the second positioning-information acquiring module 19B.

Specifically, the switching control unit 53 determines whether the satisfactory-reception-environment condition is satisfied in GPS and GLONASS and whether the additional satisfactory-reception-environment condition is satisfied in GPS and GLONASS. In the present embodiment, the switching control unit 53 can set, as the additional satisfactory-reception-environment condition, a condition that a state where the reception mode which is shown by the additional GPS information or the additional GLONASS information is the 3D Fix mode, and the number of satellites used in positioning is larger than 6, and satellite arrangement is appropriate (for example, DOP<3), and location error information is not inappropriate (for example, GST<5) should continue for a predetermined period (for example, 5 seconds or more). In a case where both of the satisfactory-reception-environment condition and the additional satisfactory-reception-environment condition are satisfied in any one of GPS and GLONASS, the switching control unit 53 determines that the reception environment of reception signals corresponding to the corresponding positioning system is better, and performs positioning based on only the first positioning-information acquiring module 19A or the second positioning-information acquiring module 19B corresponding to the corresponding positioning system. Meanwhile, in a case of determining that any one of the GPS signal reception environment and the GLONASS signal reception environment is not better, the switching control unit 53 performs positioning based on both of the first positioning-information acquiring module 19A and the second positioning-information acquiring module 19B.

[Operations]

Now, the operations of the information processing device 1 will be described.

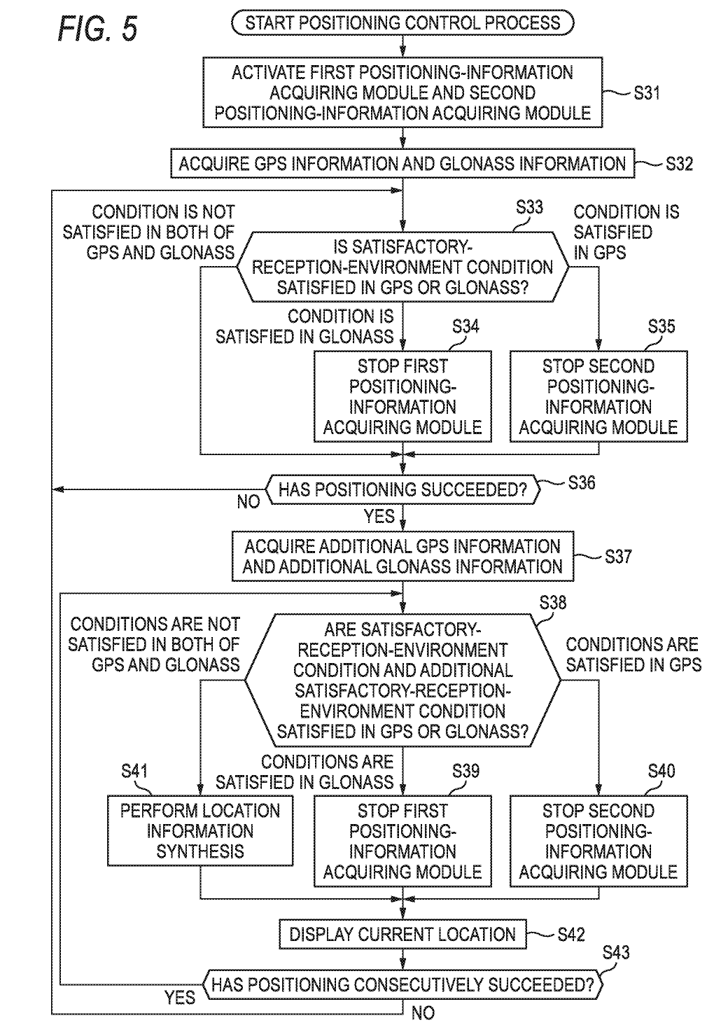

FIG. 5 is a flow chart for explaining the flow of a positioning control process which is performed by the information processing device 1 according to the third embodiment.

If an operation for activating the positioning control process is performed on the input unit 13 by a user, the positioning control process is started.

In STEP S31, the switching control unit 53 activates the first positioning-information acquiring module 19A and the second positioning-information acquiring module 19B.

In STEP S32, the switching control unit 53 acquires GPS information from the GPS information acquiring unit 51 while acquiring GLONASS information from the GLONASS information acquiring unit 52. Specifically, the switching control unit 53 acquires the number of reception satellites of GPS satellites and the levels of reception signals from the individual GPS satellites, from the GPS information, while acquiring the number of reception satellites of GLONASS satellites and the levels of reception signals from the individual GLONASS satellites, from the GLONASS information.

In STEP S33, the switching control unit 53 determines whether the satisfactory-reception-environment condition is satisfied in GPS and GLONASS. Specifically, the switching control unit 53 determines whether a state where the number of reception satellites of the GPS satellites which is shown by the GPS information is 8 or more and the C/N average of the levels of reception signals from the individual GPS satellites is 30 [dB] or more has continued for the predetermined period (for example, 5 seconds or more). Similarly, the switching control unit 53 determines whether a state where the number of reception satellites of the GLONASS satellites which is shown by the GLONASS information is 8 or more and the C/N average of the levels of reception signals from the individual GLONASS satellites is 30 [dB] or more has continued for the predetermined period (for example, 5 seconds or more).

In a case where it is determined in STEP S33 that the satisfactory-reception-environment condition is satisfied only in GLONASS, the process proceeds to STEP S34.

Meanwhile, in a case where it is determined in STEP S33 that the satisfactory-reception-environment condition is satisfied only in GPS, the process proceeds to STEP S35.

Also, in a case where it is determined in STEP S33 that the satisfactory-reception-environment condition is not satisfied in both of GPS and GLONASS, the process proceeds to STEP S36.

Also, in a case where it is determined in STEP S33 that the satisfactory-reception-environment condition is satisfied in both of GPS and GLONASS, the process proceeds to any one of STEPS S34 and S35.

In STEP S34, the switching control unit 53 stops the operation of the first positioning-information acquiring module 19A. Also, as a mode in which the operation of the first positioning-information acquiring module 19A is stopped, it is possible to set various modes for making power consumption less than that during normal operation, such as modes in which electric power for the first positioning-information acquiring module 19A is cut off, or the first positioning-information acquiring module 19A is switched to a sleep state, or the first positioning-information acquiring module 19A is intermittently activated.

In STEP S35, the switching control unit 53 stops the operation of the second positioning-information acquiring module 19B. Also, as a mode in which the operation of the second positioning-information acquiring module 19B is stopped, it is possible to set various modes for making power consumption less than that during normal operation, such as modes in which electric power for the second positioning-information acquiring module 19B is cut off, or the second positioning-information acquiring module 19B is switched to a sleep state, or the second positioning-information acquiring module 19B is intermittently activated.

In STEP S36, the switching control unit 53 determines whether positioning based on only GPS or GLONASS or positioning based on both of GPS and GLONASS has succeeded. For example, the switching control unit 53 can determine whether positioning based on GPS or GLONASS has succeeded, based on whether the reception mode is the 2D mode or the 3D Fix mode.

In a case where positioning based on only GPS or GLONASS or positioning based on both of GPS and GLONASS has succeeded, the determination result of STEP S36 becomes “YES”, and the process proceeds to STEP S37.

Meanwhile, in a case where positioning based on only GPS or GLONASS or positioning based on both of GPS and GLONASS has not succeeded, the determination result of STEP S36 becomes “NO”, and the process proceeds to STEP S33.

In STEP S37, the switching control unit 53 acquires additional GPS information from the GPS information acquiring unit 51 while acquiring additional GLONASS information from the GLONASS information acquiring unit 52.

In STEP S38, the switching control unit 53 determines whether the satisfactory-reception-environment condition and the additional satisfactory-reception-environment condition are satisfied in GPS and GLONASS. Specifically, the switching control unit 53 determines whether a state where the number of reception satellites of the GPS satellites which is shown by the GPS information is 8 or more and the C/N average of the levels of reception signals from the individual GPS satellites is 30 [dB] or more has continued for the predetermined period (for example, 5 seconds or more), as the satisfactory-reception-environment condition of GPS. Also, the switching control unit 53 determines whether a state where the reception mode which is shown by the additional GPS information is the 3D Fix mode, and the number of satellites used in positioning is larger than 6, and satellite arrangement is appropriate (for example, DOP<3), and location error information is not inappropriate (for example, GST<5) has continued for the predetermined period (for example, 5 seconds or more), as the additional satisfactory-reception-environment condition of GPS. Further, the switching control unit 53 determines whether a state where the number of reception satellites of the GLONASS satellites which is shown by the GLONASS information is 8 or more and the C/N average of the levels of reception signals from the individual GLONASS satellites is 30 [dB] or more has continued for the predetermined period (for example, 5 seconds or more), as the satisfactory-reception-environment condition of GLONASS. Furthermore, the switching control unit 53 determines whether a state where the reception mode which is shown by the additional GLONASS information is the 3D Fix mode, and the number of satellites used in positioning is larger than 6, and satellite arrangement is appropriate (for example, DOP<3), and location error information is not inappropriate (for example, GST<5) has continued for the predetermined period (for example, 5 seconds or more), as the additional satisfactory-reception-environment condition of GLONASS.

In a case where it is determined in STEP S38 that the satisfactory-reception-environment condition and the additional satisfactory-reception-environment condition are satisfied only in GLONASS, the process proceeds to STEP S39.

Also, in a case where it is determined in STEP S38 that the satisfactory-reception-environment condition and the additional satisfactory-reception-environment condition are satisfied only in GPS, the process proceeds to STEP S40.

Meanwhile, in a case where it is determined in STEP S38 that the satisfactory-reception-environment condition and the additional satisfactory-reception-environment condition are not satisfied in both of GPS and GLONASS, the process proceeds to STEP S41.

Also, in a case where it is determined in STEP S38 that the satisfactory-reception-environment condition and the additional satisfactory-reception-environment condition are satisfied in both of GPS and GLONASS, the process proceeds to any one of STEPS S39 and S40.

In STEP S39, the switching control unit 53 stops the operation of the first positioning-information acquiring module 19A. Also, as a mode in which the operation of the first positioning-information acquiring module 19A is stopped, it is possible to set various modes for making power consumption less than that during normal operation, such as modes in which electric power for the first positioning-information acquiring module 19A is cut off, or the first positioning-information acquiring module 19A is switched to a sleep state, or the first positioning-information acquiring module 19A is intermittently activated.

In STEP S40, the switching control unit 53 stops the operation of the second positioning-information acquiring module 19B. Also, as a mode in which the operation of the second positioning-information acquiring module 19B is stopped, it is possible to set various modes for making power consumption less than that during normal operation, such as modes in which electric power for the second positioning-information acquiring module 19B is cut off, or the second positioning-information acquiring module 19B is switched to a sleep state, or the second positioning-information acquiring module 19B is intermittently activated.

In STEP S41, the location information synthesizing unit 54 synthesizes the location information acquired by the GPS information acquiring unit 51 and the location information acquired by the GLONASS information acquiring unit 52, thereby calculating the current location.

After STEP S39, STEP S40, or STEP S41, the process proceeds to STEP S42.

In STEP S42, the display control unit 55 displays the current location on the map information stored in the map information storage unit 71. Specifically, in a case where the satisfactory-reception-environment condition and the additional satisfactory-reception-environment condition are satisfied in GPS or GLONASS, whereby positioning based on only the first positioning-information acquiring module 19A or the second positioning-information acquiring module 19B is performed, the display control unit 55 displays the current location on the map information, based on the location information acquired by the GPS information acquiring unit 51 or the GLONASS information acquiring unit 52. Meanwhile, in a case where the satisfactory-reception-environment condition and the additional satisfactory-reception-environment condition are not satisfied, whereby positioning based on both of the first positioning-information acquiring module 19A and the second positioning-information acquiring module 19B is performed, the display control unit 55 displays the current location calculated by the location information synthesizing unit 54, on the map information.

In STEP S43, the switching control unit 53 determines whether positioning based on only GPS or GLONASS or positioning based on both of GPS and GLONASS has consecutively succeeded. For example, the switching control unit 53 can determine whether positioning based on only GPS or GLONASS has consecutively succeeded, based on whether the reception mode is the 2D mode or the 3D Fix mode.

In a case where positioning based on only GPS or GLONASS or positioning based on both of GPS and GLONASS has consecutively succeeded, the determination result of STEP S43 becomes “YES”, and the process proceeds to STEP S38.

Meanwhile, in a case where positioning based on only GPS or GLONASS or positioning based on both of GPS and GLONASS has not consecutively succeeded, the determination result of STEP S43 becomes “NO”, and the process proceeds to STEP S33.

Also, in a case where an operation for stopping the positioning control process is performed on the input unit 13 by the user, the positioning control process finishes.

According to this process, in the information processing device 1, in a case where the GPS signal reception environment or the GLONASS signal reception environment satisfies the satisfactory-reception-environment condition, positioning based on only GPS or GLONASS is performed; whereas in a case where the GPS signal reception environment and the GLONASS signal reception environment do not satisfy the satisfactory-reception-environment condition, positioning based on both of GPS and GLONASS is performed.

Further, after positioning succeeds, if the GPS signal reception environment or the GLONASS signal reception environment satisfies both of the satisfactory-reception-environment condition and the additional satisfactory-reception-environment condition, positioning based on only GPS or GLONASS is performed; whereas in a case where the GPS signal reception environment or the GLONASS signal reception environment does not satisfy both of the satisfactory-reception-environment condition and the additional satisfactory-reception-environment condition, positioning based on both of GPS and GLONASS is performed.

Therefore, in an electronic device having a positioning function based on GPS and a positioning function based on GLONASS, it is possible to perform positioning based on only a positioning system whose reception environment is satisfactory, and in a case where the reception environments of both positioning systems are not satisfactory, it is possible to perform positioning based on both of those positioning systems. Also, it is possible to determine a positioning system whose reception environment is better, and acquire a more accurate current location by lower-power-consumption control.

Therefore, according to the information processing device 1, it is possible to improve positioning performance while suppressing an increase in power consumption.

[First Modification]

In each embodiment described above, the satisfactoriness of reception environment is determined with reference to the GPS information or the GLONASS information. However, in place of this, or in addition to this, the satisfactoriness of reception environment may be determined by determining the posture of the GPS antenna 18A or the GLONASS antenna 18B. Specifically, the switching control unit 53 can determine whether the posture of the GPS antenna 18A or the GLONASS antenna 18B detected by a 3-axis gyroscope, a gyro sensor, or the like included in the sensor unit 12 is a posture degrading the reception state. In this case, if it is determined that the posture of the GPS antenna 18A or the GLONASS antenna 18B is a posture degrading the reception state (for example, a posture inclined with respect to a vertical direction by 20 degrees or more), the switching control unit 53 can determine that the reception state is not satisfactory.

In this way, it is possible to determine the satisfactoriness of reception environment by a simple process.

The information processing device 1 which is configured as described above includes the first positioning-information acquiring module 19A, the second positioning-information acquiring module 19B, and the switching control unit 53.

The first positioning-information acquiring module 19A acquires positioning information based on a first positioning system (GPS).

The second positioning-information acquiring module 19B acquires positioning information based on a second positioning system (GLONASS).

The switching control unit 53 determines the reception state of at least one of positioning information based on the first positioning system and positioning information based on the second positioning system.

Based on this determination result, the switching control unit 53 sets any one of positioning based on any one of the first positioning system and the second positioning system and positioning based on both of the first positioning system and the second positioning system.

In a case where the reception state of the first positioning system or the second positioning system satisfies a determination condition, positioning based on only the first positioning system or the second positioning system is performed; whereas in a case where the reception state of the first positioning system or the second positioning system does not satisfy the determination condition, positioning based on both of the first positioning system and the second positioning system is performed.

Therefore, in an electronic device having positioning functions based on a plurality of positioning systems, it is possible to acquire a more accurate current location by lower-power-consumption control.

Therefore, according to the information processing device 1, it is possible to improve positioning performance while suppressing an increase in power consumption.

Also, the switching control unit 53 activates the first positioning-information acquiring module 19A while stopping the second positioning-information acquiring module 19B, and then determines the positioning information reception state based on the first positioning system.

In a case where it is determined that the positioning information reception state based on the first positioning system satisfies the determination condition, the switching control unit 53 sets positioning based on the first positioning system; whereas in a case where it is determined that the positioning information reception state based on the first positioning system does not satisfy the determination condition, the switching control unit 53 sets positioning based on both of the first positioning system and the second positioning system.

In this way, according to the reception state, it is possible to perform switching to positioning based on only the first positioning system or positioning based on the first positioning system and the second positioning system, in preference to the first positioning system.

Also, in a case where the reception state of at least one of positioning information based on the first positioning system and positioning information based on the second positioning system satisfies a first determination condition, the switching control unit 53 further determines whether the reception state of at least one of positioning information based on the first positioning system and positioning information based on the second positioning system satisfies a second determination condition for determining which of them is better.

Based on the determination result based on the second determination condition, the switching control unit 53 further sets any one of positioning base on any one of the first positioning system and the second positioning system and positioning based on both of the first positioning system and the second positioning system.

Therefore, it is possible to determine a positioning system whose reception state is better, and acquire a more accurate current location by lower-power-consumption control.

Also, the switching control unit 53 determines a condition including at least one of the number of reception satellites and the levels of reception signals from the individual satellite, as the first determination condition, and determines a condition including at least one of the reception mode, the number of satellites used in positioning, satellite arrangement, and location error information, as the second determination condition.

Therefore, it is possible to more accurately determine a positioning system whose reception state is better, by the second determination condition defined by positioning information more concrete than those of the first determination condition.

Also, the switching control unit 53 activates both of the first positioning-information acquiring module 19A and the second positioning-information acquiring module 19B, and determines the reception state of positioning information based on the first positioning system and the reception state of positioning information based on the second positioning system.

In a case of setting positioning based on any one of the first positioning system and the second positioning system based on the determination result, the switching control unit 53 keeps one of the first positioning-information acquiring module 19A and the second positioning-information acquiring module 19B active and stops the other one.

Therefore, it is possible to perform positioning based on only a positioning system whose reception state is satisfactory and it is possible to stop a module for performing positioning based on the other positioning system. Therefore, it is possible to perform more accurate positioning immediately after start of positioning while suppressing an increase in power consumption.

Also, the present invention is not limited to the embodiments described above, and modifications, improvements, and the like made within a range in which it is possible to achieve the object of the present invention are included in the present invention.

For example, the present invention can be embodied by combining the functions of the information processing devices 1 disclosed in the embodiments and the modifications described above.

In the above described embodiments, with respect to the individual determination conditions for determining the satisfactoriness of reception environment, appropriate changes such as determination condition elimination or addition, logical sum, or logical product may be made in order to perform more accurate determination.

Also, in the embodiments, the case of using GPS and GLONASS as positioning systems has been described as an example. However, the present invention can be applied in a case of performing positioning based on at least one of various positioning systems.

Also, in the embodiments, the information processing apparatuses have been described as examples of the electronic device according to the present invention. However, the present invention is not particularly limited thereto.

For example, the present invention can be generally applied to electronic devices having positioning functions. Specifically, for example, the present invention can be applied to various devices such as a notebook type perspective conversion, a television set, a video camera, a mobile navigation device, a mobile phone, a smart phone, and a portable game machine.

The series of processes described above can be performed by hardware, and can also be performed by software.

In other words, the functional configuration of FIG. 2 is merely illustrative, and does not particularly limit the present invention. That is, the information processing device 1 needs only to have a function capable of performing the series of processes described above, as a whole, and functional blocks usable for implementing that function are not particularly limited to the example of FIG. 2.

Also, one functional block may be configured by only hardware, or may be configured by only software, or may be configured by a combination of hardware and software.

In a case of performing the series of processes by software, a program constituting the software is installed from a network or a recording medium into a computer or the like.

The computer may be a computer integrated in dedicated hardware. Alternatively, the computer may be a computer which can perform various functions by installing by various programs, for example, a general-purpose computer.

A recording medium retaining that program can be configured by the removable medium 31 of FIG. 1 which is distributed separately from the device in order to provide the program to the user, and can also be configured by a recording medium or the like which is provided to the user in a state where it is installed in the device in advance. The removable medium 31 may be composed of, for example, a magnetic disk (including a floppy disk), an optical disk, or a magneto-optical disk. An optical disk is compose of, for example, a compact disk-read only memory (CD-ROM), a digital versatile disk (DVD), or a Blu-ray (registered as a trade mark) disc. A magneto-optical disk is composed of a Mini-Disk (MD) or the like. Also, a recording medium which is provided to the user in a state where it is installed in the device in advance may be composed of, for example, the ROM 16 of FIG. 1 retaining programs.

Also, in this specification, steps describing programs to be recorded in a recording medium include not only processes which are performed in the order of them in a time series, but also processes which are performed in parallel or individually.

Although some embodiments of the present invention have been described above, those embodiments are merely illustrative and do not limit the technical range of the present invention. The present invention can take other various embodiments, and various modifications such as omission and replacement can be made without departing the gist of the present invention. These embodiments and modifications are included in the scope and gist of the invention described in this specification and the like, and are included in the scope of the inventions disclosed in claims and their equivalents.

What is claimed is:

1. An electronic device comprising:
a first positioning-information acquiring module that acquires positioning information based on a first positioning system using signals which are received from first satellites;
a second positioning-information acquiring module that acquires positioning information based on a second positioning system using signals which are received from second satellites, the second satellites being different type from the first satellites; and
a processing unit that performs:
a reception state determining process of determining at least one of a reception state of signals from the first satellites and a reception state of signals from the second satellites; and
a positioning system setting process of setting a positioning system based on at least one of the first positioning system and the second positioning system based on a determination result of the reception state determining process.

2. The electronic device according to claim 1, wherein:
in the positioning system setting process, based on the determination result of the reception state determining process, the processing unit sets any one of (i) positioning based on any one of the first positioning system and the second positioning system and (ii) positioning based on both of the first positioning system and the second positioning system.

3. The electronic device according to claim 2, wherein:
in the reception state determining process, the processing unit activates the first positioning-information acquiring module while stopping the second positioning-information acquiring module, and determines the reception state of the positioning information based on the first positioning system,
in a case where the processing unit determines that the reception state of the positioning information based on the first positioning system satisfies a determination condition in the reception state determining process, the processing unit sets positioning based on the first positioning system in the positioning system setting process, and
in a case where the processing unit determines that the reception state of positioning information based on the first positioning system does not satisfy the determination condition in the reception state determining process, the processing unit sets positioning based on both of the first positioning system and the second positioning system in the positioning system setting process.

4. The electronic device according to claim 2, wherein:
in the reception state determining process, the processing unit determines whether the reception state of at least one of positioning information based on the first positioning system and positioning information based on the second positioning system satisfies (i) a first determination condition for determining whether each reception state is a first state, or (ii) a second determination condition for determining whether each reception state is a second state, the second state being better than the first state, and
in the positioning system setting process, based on the determination result of the second determination condition in the reception state determining process, the processing unit sets any one of (i) positioning based on any one of the first positioning system and the second positioning system and (ii) positioning based on both of the first positioning system and the second positioning system.

5. The electronic device according to claim 4, wherein:
in the reception state determining process, the processing unit determines a condition including at least one of the number of reception satellites and levels of reception signals from individual satellites, as the first determination condition, and
in the reception state determining process, the processing unit determines a condition including at least one of a reception mode, the number of satellites used in positioning, a satellite arrangement, and location error information, as the second determination condition.

6. The electronic device according to claim 3, wherein:
in the reception state determining process, the processing unit determines whether the reception state of at least one of positioning information based on the first positioning system and positioning information based on the second positioning system satisfies (i) a first determination condition for determining whether each reception state is a first state, or (ii) a second determination condition for determining whether each reception state is a second state, the second state being better than the first state, and
in the positioning system setting process, based on the determination result of the second determination condition in the reception state determining process, the processing unit sets any one of (i) positioning based on any one of the first positioning system and the second positioning system and (ii) positioning based on both of the first positioning system and the second positioning system.

7. The electronic device according to claim 4, wherein:
in the reception state determining process, the processing unit determines whether a first state continues for a predetermined period, as the first condition,
the first state includes a state (i) where the number of reception satellites of the first satellites or the second satellites is a first value or more and (ii) where quality of reception signals from the first satellites or the second satellites is a second value or more, and
in the reception state determining process, the processing unit determines whether a second state continues for a predetermined period, as the second condition,
the second state includes a state (i) where a reception mode of the first satellites or the second satellites is a predetermined mode, (ii) where the number of satellites used in positioning is a third value or more, (iii) where a numerical value representing an arrangement of the first satellites or the second satellites is a fourth value or more, and (iv) where a numerical value representing location error information is a fifth value or less.

8. The electronic device according to claim 6, wherein:
the first satellites are GPS satellites, and
in the reception state determining process, the processing unit determines whether a first state continues for a predetermined period, as the first condition,
the first state includes a state (i) where the number of reception satellites of the GPS satellites is eight or more, and (ii) where the C/N of reception signals from the GPS satellites is 30 dB or more, and
in the reception state determining process, the processing unit determines whether a second state continues for a predetermined period, as the second condition,
the second state includes a state (i) where a reception mode of the GPS satellites is a 3D Fix mode, (ii) where the number of satellites used in positioning is six or more, (iii) where DOP representing an arrangement of the GPS satellites is three or more, and (iv) where GST representing location error information is less than five.

9. The electronic device according to claim 6, wherein:
the second satellites are GLONASS satellites, and
in the reception state determining process, the processing unit determines whether a first state continues for a predetermined period, as the first condition,
the first state includes a state (i) where the number of reception satellites of the GLONASS satellites is eight or more, and (ii) where the C/N of reception signals from the GLONASS satellites is 30 dB, and
in the reception state determining process, the processing unit determines whether a second state continues for a predetermined period, as the second condition,
the second state includes a state (i) where a reception mode of the GLONASS satellites is a 3D Fix mode, (ii) where the number of satellites used in positioning is six or more, (iii) where DOP representing an arrangement of the GLONASS satellites is three or more, and (iv) where GST representing location error information is less than five.

10. The electronic device according to claim 2, wherein:
in the reception state determining process, the processing unit activates both of the first positioning-information acquiring module and the second positioning-information acquiring module, and determines the reception state of positioning information based on the first positioning system and the reception state of positioning information based on the second positioning system, respectively, and
in a case of setting positioning based on any one of the first positioning system and the second positioning system based on the determination result in the positioning system setting process, the processing unit keeps one of the first positioning-information acquiring module and the second positioning-information acquiring module active, and stops the other one of the first positioning-information acquiring module and the second positioning-information acquiring module active.

11. The electronic device according to claim 1, wherein:
the first positioning-information acquiring module includes a first antenna which receives signals from the first satellites,
the second positioning-information acquiring module includes a second antenna which receives signals from the second satellites, and
in the reception state determining process, based on a posture of any one of the first antenna and the second antenna, the processing unit determines at least one of the reception state of signals from the first satellites and the reception state of signals from the second satellites.

12. A positioning control method which is used in an electronic device including a first positioning-information acquiring module that acquires positioning information based on a first positioning system using signals which are received from first satellites, and a second positioning-information acquiring module that acquires positioning information based on a second positioning system using signals which are received from second satellites, the second satellites being different type from the first satellites, the method comprising:
determining at least one of a reception state of signals from the first satellites and a reception state of signals from the second satellites; and
setting a positioning system based on at least one of the first positioning system and the second positioning system based on a determination result of the reception state determining step.

13. A non-transitory computer readable storage medium storing a program which causes a computer to control an electronic device including a first positioning-information acquiring module that acquires positioning information based on a first positioning system using signals which are received from first satellites, and a second positioning-information acquiring module that acquires positioning information based on a second positioning system using signals which are received from second satellites, the second satellites being different type from the first satellites, the program causing the computer to perform processes comprising:
determining at least one of a reception state of signals from the first satellites and a reception state of signals from the second satellites; and
setting a positioning system based on at least one of the first positioning system and the second positioning system based on a determination result of the reception state determining step.

14. An electronic device comprising:
a GPS positioning-information acquiring module that acquires positioning information based on a GPS positioning system using signals which are received from GPS satellites;
a GLONASS positioning-information acquiring module that acquires positioning information based on a GLONASS positioning system using signals which are received from GLONASS satellites; and
a processing unit that performs:
a reception state determining process of determining whether a reception state satisfies a condition (i) where the number of reception satellites of the GPS satellites is a first value or more and (ii) where quality of reception signals from the GPS satellites is a second value or more, satisfied; and
a positioning system setting process of setting the GPS positioning system when the reception state is satisfied the condition, and setting both of the GPS positioning system and the GLONASS positioning system when the reception state is not satisfied the condition.
